(19) United States
(12) Patent Application Publication
(10) Pub. No.: US 2012/0099771 A1
(43) Pub. Date: Apr. 26, 2012

(54) COMPUTER AIDED DETECTION OF ARCHITECTURAL DISTORTION IN MAMMOGRAPHY

(76) Inventor: Zhiqiang Lao, New Town, PA (US)

(21) Appl. No.: 12/908,030

(22) Filed: Oct. 20, 2010

(51) Int. Cl. G06K 9/00

(52) U.S. Cl. 382/131

(57) ABSTRACT

A method for detecting architectural distortion within mammographic image data. The method identifies breast tissue within the image data, generates an orientation field and a corresponding magnitude field within the identified breast tissue and generates a feature map by processing the orientation field with a phase portrait model at one or more image scales. The method identifies one or more architectural distortion features according to the generated feature map and displays the one or more identified architectural distortion features.

### FIELD OF THE INVENTION

The present invention generally relates to image processing and analysis and computer-aided detection (CAD) and more particularly relates to methods that assess and use data related to the detection of architectural distortion in mammography.

### BACKGROUND OF THE INVENTION

Some believe that indirect signs of malignancy (such as: architectural distortion, bilateral asymmetry, single dilated duct and developing densities) account for almost 20% of detected breast cancer. Architectural distortion is believed to be a sign of nonpalpable breast cancer. Architectural distortion is defined in the Breast Imaging Reporting and Data System (BI-RADS) as follows: “The normal architecture (of the breast) is distorted with no definite mass visible. This includes spiculations radiating from a point and focal retraction or distortion at the edge of the parenchyma. Architectural distortion can also be an associated finding.”

FIG. 1 shows an example of architectural distortion in a mammography image 100. Architectural distortion can be a subtle effect in which a lesion mimics the appearance of overlapping breast tissue. Due to its relative subtlety and variable presentation, architectural distortion is a commonly missed abnormalities in screening mammography. Architectural distortion can account for breast cancer being overlooked or misinterpreted in mammography screening. A recent study that analyzed false negative mammograms showed that improvement in the detection of architectural distortion could lead to improvement in the prognosis of breast cancer patients.

Although most architectural distortions are considered to represent cancer, it is difficult for radiologists to detect this condition because of the nonspecific definition of distortion and due to its subtle nature. This also represents a challenge for computer aided detection. A number of widely available mammography CAD systems showed sensitivity to architectural distortion of less than 50%. Thus, the development of CAD system for detecting architectural distortion is a challenging topic in this field.

Eltonsy et al. in “A concentric morphology model for the detection of masses in mammography” (IEEE Transactions on Medical Imaging, 2007, vol. 26, no. 6, pp. 880-889) developed a method to detect masses and architectural distortion by locating points surrounded by concentric layers of image activity.

Zwiggelear et al. in “Model-based detection of spiculated lesions in mammograms” (Medical Image Analysis, 1999, vol. 3, no. 1, pp. 39-62) proposed a scheme for the detection of spiculated mass lesion.

Rangayyan et al. in “Detection of architectural distortion in prior mammograms of interval-cancer cases with neural networks” (31^{st} Annual international conference of the IEEE EMBS, 2009, Minneapolis, Minn., USA) proposed a method based on Gabor filters and phase portrait analysis to detect initial candidates for sites of architectural distortion.

Baker et al. in “Computer-aided detection (CAD) in screening mammography: sensitivity of commercial CAD systems for detecting architectural distortion” (American Journal of Roentgenology, 2003, vol. 181, pp. 1083-1088) investigated the performance of two commercial CAD systems, including detecting architectural distortion.

While various methods such as those listed may have achieved some level of success in detecting architectural distortion in the mammography image, improvement remains. For example, there is a need for further effort in this area to improve the accuracy of the detection, particularly for commercial systems. Moreover, developments in this area, such as detection of spiculation, may help to improve detection and diagnostic results for other types of conditions. Features used in architectural distortion detection can further benefit the detection of spiculated mass and boost the accuracy for detection of mass in mammography, which can be a significant bottle-neck of current mammographic CAD system.

Overall, advances in the detection of architectural distortion in the mammography image can better assist the radiologist to improve performance in mammography screening and can help to reduce false negatives. This capability helps to boost the detection accuracy of the mammography system and to provide consistent detection of two major breast cancer subtypes, i.e. mass and architectural distortion, thus helping to assist in providing earlier diagnosis and treatment for breast cancer patients.

### SUMMARY OF THE INVENTION

It is an object of the present invention to advance the art of computer-aided detection for mammography and other tissue imaging. With this object in mind, the present invention provides a method for detecting architectural distortion within mammographic image data, the method executed at least in part on a computer and comprising: identifying breast tissue within the image data; generating an orientation field and a corresponding magnitude field within the identified breast tissue; generating a feature map by processing the orientation field with a phase portrait model at one or more image scales; identifying one or more architectural distortion features according to the generated feature map; and displaying the one or more identified architectural distortion features.

The present invention is suitable for modeling both spiculation and distortion simultaneously. Such an approach helps in the detection of both architectural distortion and spiculated mass in mammography.

It is an advantage of the present invention that it is relatively insensitive to differences in image contrast or other image quality characteristics or to differences due to the specific type of radiology system used for obtaining the image.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

### BRIEF DESCRIPTION OF THE DRAWINGS

The foregoing and other objects, features, and advantages of the invention will be apparent from the following more particular description of the embodiments of the invention, as illustrated in the accompanying drawings.

The elements of the drawings are not necessarily to scale relative to each other.

FIG. 1 is an example mammography image with architectural distortion.

FIG. 2 is a logic flow diagram showing basic steps for the detection of architectural distortion in one embodiment of the present invention.

FIGS. 3A, 3B, and 3C show the sequence of processing that follow the general flow given in FIG. 2, with accompanying views of breast tissue to illustrate a number of the processing steps.

FIG. 4A is a diagram that illustrates the use of a Gabor filter bank for generating a filtered magnitude field and corresponding orientation field for a given image.

FIG. 4B shows processing of a high-pass filtered image by a Gabor filter bank for generating an orientation field and a magnitude field.

FIG. 5 is a flow diagram that shows processing steps for generation of a refined orientation field from the draft orientation field generated by the Gabor filter bank using a non-maximum suppression technique.

FIG. 6A is a flow diagram that shows processes for smoothing the refined orientation field to eliminate possible noisy orientation information.

FIG. 6B is an enlargement of the smoothed orientation field of FIG. 6A.

FIG. 7 is a table that shows categories of phase portrait template, properties and typical shapes for each category.

FIGS. 8A and 8B show the sequence of steps for generating the architectural distortion feature map using multi-scale phase portrait modeling and matching of a refined orientation field.

FIG. 9 is a block diagram that shows components used in a CAD system for mammography image data processing in one embodiment.

FIG. 10 shows a plan view of a display configured as a control console for operator entry of variable processing parameters.

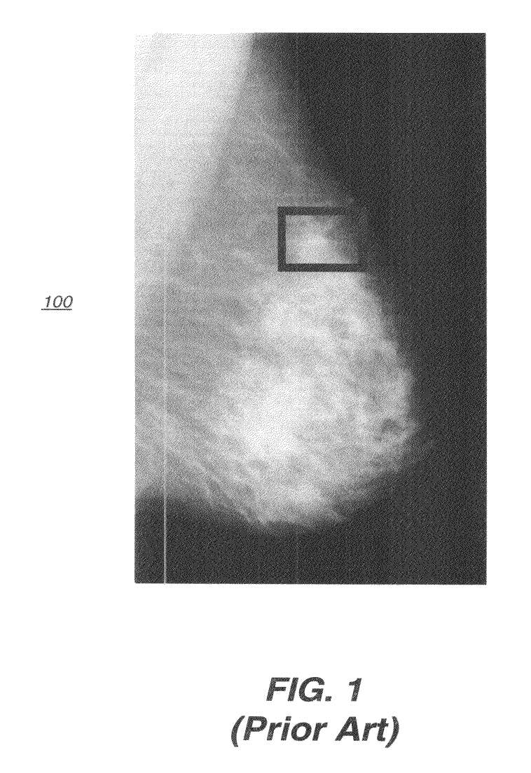

### DETAILED DESCRIPTION OF THE INVENTION

The following is a detailed description of the preferred embodiments of the invention, reference being made to the drawings in which the same reference numerals identify the same elements of structure in each of the several figures.

For the detailed description that follows, the mammographic image is defined as f(X), where X denotes the 2D pixel array and f(x,y) denotes the intensity value for pixel (x,y) in X.

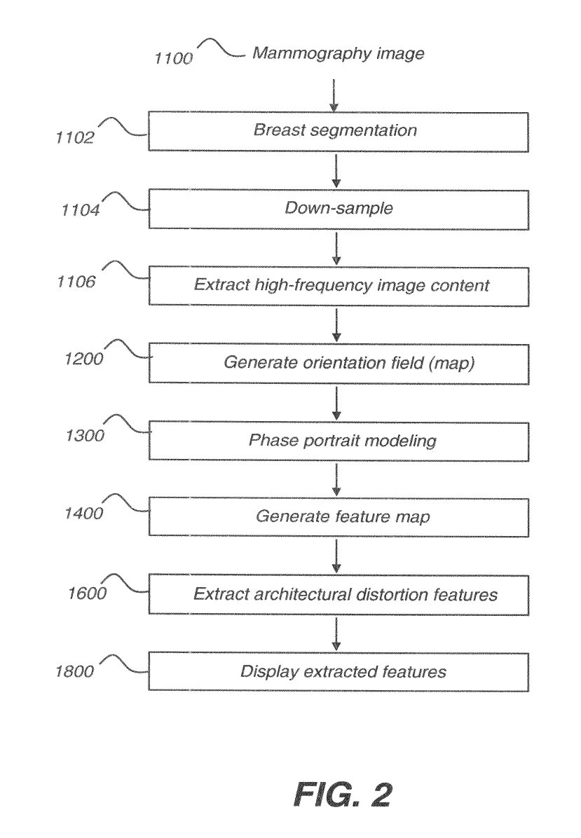

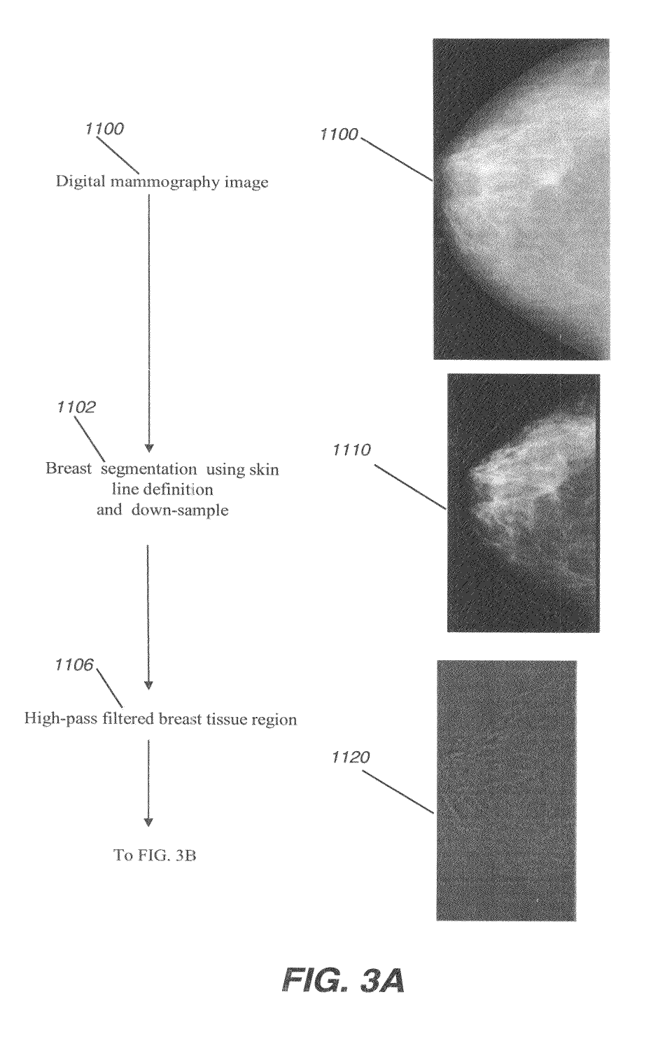

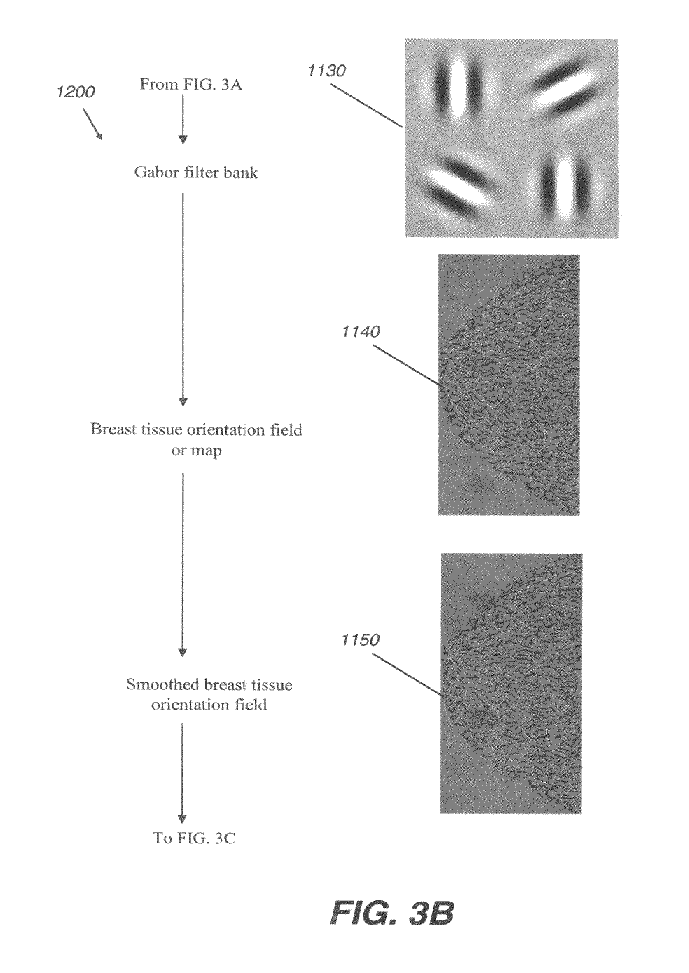

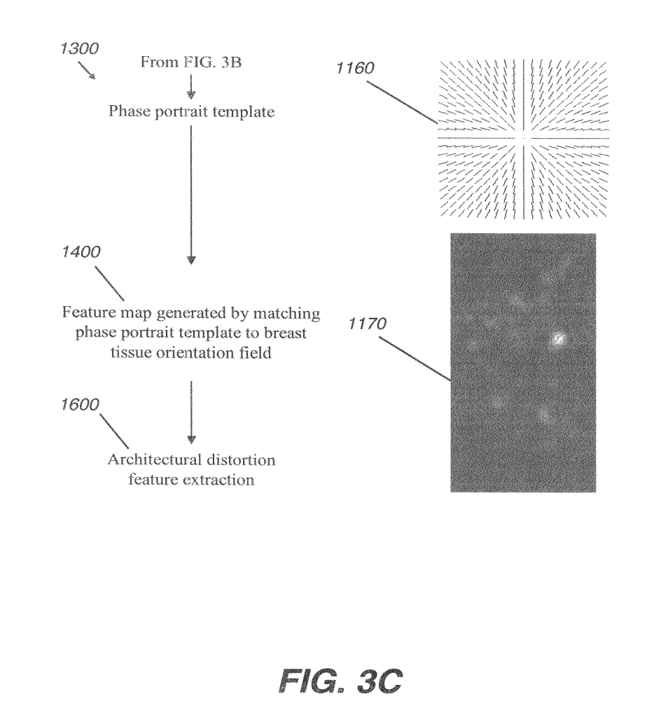

The logic flow diagram of FIG. 2 and supporting graphical sequence of FIGS. 3A, 3B, and 3C show a basic sequence for generating features to detect architectural distortion from a digital mammography image 1100. The image data can be from a scanned film x-ray, or from a computed-radiography (CR) system, or from a digital radiography (DR) system. Both cranio-caudal (CC) views and medio-lateral oblique (MLO) views are processed in the same manner. More detailed information on individual steps is given following an initial summary description.

A segmentation step 1102 defines the outline of the breast tissue in mammography image 1100. Segmentation techniques of various types are well known to those skilled in the diagnostic image processing art. In one embodiment, segmentation of the breast image is provided using a skin line estimation process that defines the contour of the breast tissue (in the CC view) or the breast tissue plus pectoral muscle (in the MLO view). The bounding box of the skin-line contour defines a breast tissue region of interest (ROI). A down-sampling step 1104 then reduces the scale of a breast ROI image 1110 to a more favorable resolution for processing. This helps to make processing more efficient, without loss of accuracy, since it has been found that the effective size of an architectural distortion lesion is statistically larger than that of a regular mass lesion. If the working pixel size used in the detection of architectural distortion is too small, subsequent processing phases for phase portrait template matching may not be able to detect the required patterns and may generate an erroneous feature map.

Still following the processing shown in FIG. 2, the down-sampled image is then processed in a high-pass filter step 1106 to extract high-frequency image content so that anatomy related image structure can be processed in subsequent processing steps. FIG. 3A shows a high-pass filtered ROI 1120.

Continuing with the FIG. 2 sequence, an orientation field generation step 1200 then provides an orientation field, alternately termed an orientation map, that is used to identify underlying structure for determining architectural distortion. The orientation field or map can be generated in a number of ways. In one embodiment, step 1200 uses a Gabor filter bank followed by non-maximum suppression technique to generate the orientation field and provides further smoothing for the orientation field, as described in more detail subsequently. FIG. 3B shows one example representation of a Gabor filter bank 1130 used for this function and shows a representative orientation field 1140 and a smoothed orientation field 1150. A phase portrait modeling and matching step 1300 then uses the orientation field that was extracted and smoothed in step 1200 as input and applies multi-scale phase portrait model templates to match and recognize the desired image structure. FIG. 3C shows an exemplary phase portrait template 1160.

Continuing with FIG. 2, a feature map generation step 1400 uses the results of phase portrait modeling and matching step 1300 in order to generate a feature map 1170 (FIG. 3C) based on node patterns identified in phase portrait modeling. A feature extraction step 1600 then extracts architectural distortion features. A display step 1800 displays the identified architectural distortion features for a diagnostician or other viewer. The display may highlight the architectural distortion feature in any of a number of ways, including outlining, use of a color, or use of a particular symbol, for example. An indicator of relative risk is also displayed in one embodiment. Factors used to determine relative risk include confidence level information related to the processed data and other variables such as size, location, and number of features identified.

### High-Pass Filtering Step 1106

Following segmentation, non breast tissue has been removed from the breast tissue ROI. At this point, the breast tissue ROI employs further enhancement to help highlight high frequency information. This is done by applying a high-pass filter to the original breast tissue ROI image. In one embodiment, the high-pass filter is implemented by the subtracting a Gaussian smoothed version of the original breast tissue ROI from the original breast tissue ROI image:

f_{HPF}(X)=f(X)−f_{LPF}(X),

where f_{HPF}(X) and f_{LPF}(X) are high-pass and low-pass filtered breast tissue ROIs. High frequency image information allows improved enhancement of underlying image structure.

### Orientation Field Generation

As the sequence of FIGS. 2 through 3B show, orientation field generation step 1200 analyzes high pass filtered ROI 1120 to produce orientation field 1140 that helps to further enhance the underlying structure of architectural distortion features for subsequent processing. As noted previously, one method for generating orientation field 1140 is to use a bank of Gabor filters.

The Gabor filter has been used in pattern recognition applications as a preprocessing step to extract orientation related image structure from raw image data. Frequency and orientation representations using Gabor filters are similar to those of the human visual system, and it has been found to be particularly appropriate for texture representation and discrimination. Gabor filters may be used as line detectors that are useful, for example, in fingerprint recognition applications. A bank of Gabor filters, each filter disposed at a different angle, is used for this function.

In diagnostic image processing applications, Gabor filtering has been proposed for use in mass candidate detection, as described in U.S. Patent Application Publication No. 2010/0046814 entitled “Method for Mass Candidate Detection and Segmentation in Digital Mammograms” by Dewaele et al. U.S. Pat. No. 6,137,398 entitled “Gabor Filtering for Improved Microcalcification Detection in Digital Mammograms” by Broussard et al. describes using Gabor filters for detecting false positive microcalcification structures so that they can be eliminated from further processing.

Unlike these earlier approaches, embodiments of the present invention, directed to the task of identifying architectural distortion, employ a bank of Gabor filters as a utility for forming an orientation field or map of breast tissue, as described earlier with reference to FIGS. 2 and 3B. Overall patterns in the orientation field, in conjunction with magnitude information, then serve as clues for improved identification of architectural distortion. Subsequent steps then apply further processing using the orientation and magnitude information obtained from this mapping.

In the example of FIG. 3B, a set or bank of four individual Gabor filters within Gabor filter bank 1130 are shown, with their respective orientations at 0, 45, 90, and 135 degrees. A bank of Gabor filters can have any suitable number of filters, each at a different angular orientation. In one embodiment, successive Gabor filters in the bank differ from each other by 5 degree increments. Thus, for example, a bank of 36 Gabor filters can be used for processing, emphasizing image structures that are oriented at any angle in the image from 0 to 180 degrees.

A 2D Gabor filter can be conceptualized as a complex plane wave carrier modulated by a 2D Gaussian envelope. A 2D Gabor filter kernel oriented at the angle

$$θ = - \frac{π}{2}$$

can be defined as follows:

$$g ( x , y ) = \frac{1}{2 {πσ}_{x} {σ}_{y}} {e}^{- \frac{1}{2} ( \frac{{x}^{2}}{{σ}_{x}^{2}} + \frac{{y}^{2}}{{α}_{y}^{2}} )} cos ( 2 π fx ) \qquad ( 1 )$$

Kernels at other angles can be obtained by rotating this kernel. In this embodiment, the parameters in Eq. 1, namely: σₓ, σ_{y} and f are derived from design rules as follows:
Let τ be the full-width and half-maximum of the Gaussian term in Eq. 1 along the x axis. Then, σₓ=τ/(2\sqrt{2 ln 2})=τ/2.35.
The cosine term is designed to have a period of τ; therefore,

$$f = \frac{1}{τ} .$$

The value of σₓ is defined as σ_{y}=lσₓ, where l determines the elongation of the Gabor filter in they direction, as compared to the extent of the filter in the x direction.

In one embodiment, value τ=4 pixels (corresponding to a thickness of 4 cm at a pixel size of 1 cm) and l=8. These values were determined empirically, by observing the typical spicule width and length in mammograms with architectural distortion in a patient database. This is based on a comparative analysis of the Gabor filter with the steerable filter and a 5×5 line detection mask.

The Gabor filter has a nonzero magnitude response at the origin of the frequency plane (DC frequency). Consequently, the low-frequency components of the mammographic image may influence the result of the Gabor filter. Such influence does not affect the computation of the orientation field angle, since the same influence will appear at all angles. However, the nonzero DC response can cause the orientation field magnitude to exhibit values that are affected by low-frequency content of the image. It is thus desirable to reduce the influence of the low-frequency components of the mammographic image in the orientation field magnitude, since the low-frequency components are not related to the presence of oriented structures in the image. For this reason, the mammographic image is high-pass filtered prior to the generation of the orientation field, as has been noted.

The texture orientation at a pixel is estimated as the orientation of the Gabor filter that yields the highest magnitude response at that pixel. The orientation at every pixel is then used to compute the orientation field angle image θ(x,y). The magnitude of the corresponding filter response forms the magnitude image M(x,y). The orientation field thus obtained has the same resolution as the original mammogram (1 cm).

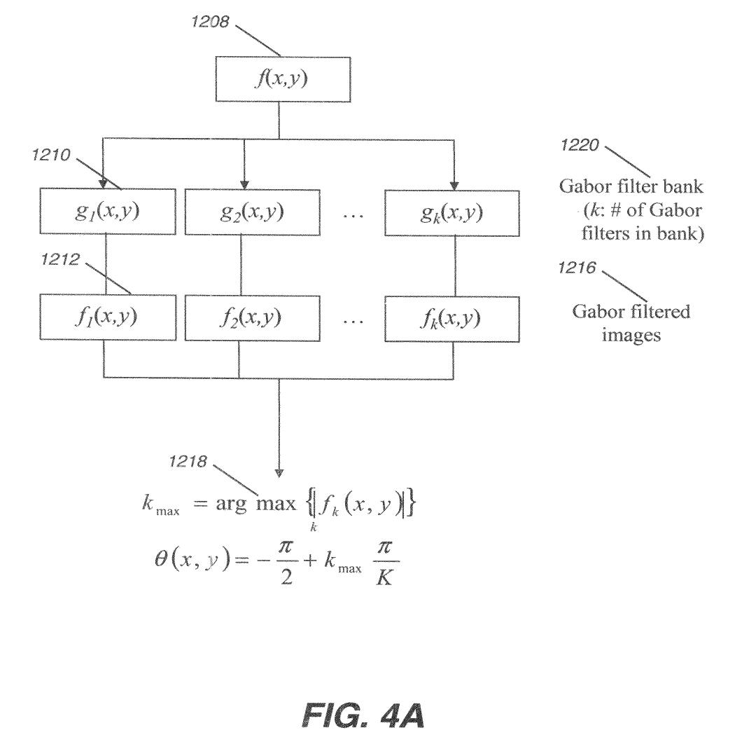

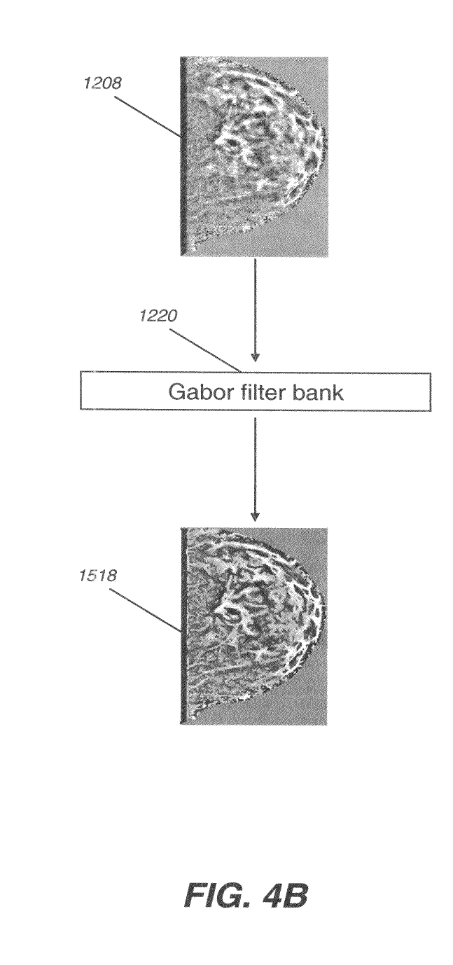

The diagram of FIG. 4A shows how Gabor-filtered images 1216 are generated from a high-pass filtered mammography image 1208. By way of example, let θ(x,y) be the texture orientation at (x,y), and each gₖ(x,y), k=0, 1, . . . 36, be a Gabor filter 1210 oriented at angle

$${α}_{k} = - \frac{π}{2} + k \frac{π}{36} .$$

Let f_{HPF}(x,y) be the high-pass-filtered version of the mammogram being processed, high-pass filtered mammography image 1208, and fₖ(x,y)=(f_{HPF}×G_{K})(x,y) represent Gabor filtered images 1212 and 1216. Then, the orientation field angle of f(x,y) is given by a step 1218:

$$θ ( x , y ) = {α}_{{k}_{max}} , where {k}_{max} = arg \{ {max}_{k} [ \vert {f}_{k} ( x , y ) \vert ] \} \qquad ( 2 )$$

The orientation field magnitude M(x,y) is given by step 1218 as:

M(x,y)=|fₖ_{ₘₐₓ}(x,y)| (3)

FIG. 4B shows an example of generating a magnitude field image 1518 using Gabor filter bank. High-pass filtered mammography image 1208 is an example of f_{HPF}(X). A Gabor filter bank 1220 processes image 1208 and generates magnitude field image 1518 M(X).

### Non-Maximum Suppression

The Gabor filter bank is sensitive to linear structures, such as spicules and fibers. However, the filter bank also recognizes strong edges in the image as oriented features, such as: pectoral muscle edge, the parenchymal tissue edge, and vessel walls, etc. This embodiment focuses predominantly on identifying oriented features as clues for architectural distortion.

Non-Maximum Suppresion (NMS) is used to detect core curvilinear structure that shows the most pronounced textural or structural differences by comparing each pixel in magnitude image M(x,y) with its neighbors along the direction that is perpendicular to the local orientation field angle θ(x,y). If the pixel under investigation has a larger magnitude value than that of its corresponding neighbors, the pixel is considered to be a core curvilinear structure pixel.

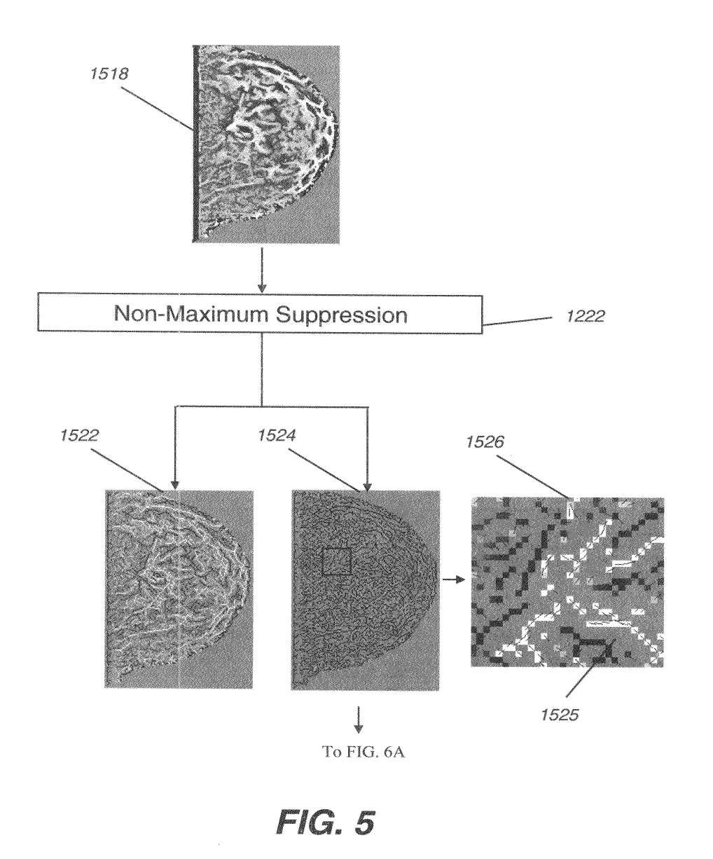

FIG. 5 shows an example for extracting curvilinear structure from the Gabor filtered magnitude field image 1518 M(x,y) and its corresponding orientation field or map θ(x,y) (not shown). A Non-Maximum Suppression step 1222 generates two resulting images corresponding to M(x,y) and θ(x,y), namely M_{NMS}(x,y) image 1522 and θ_{NMS}(x,y) image 1524. A magnified image 1526 is a zoomed-in version of the white square region in image 1524 in the NMS processed orientation field. In this combined map representation, the orientation field is overlaid on the magnitude field image. In magnified image 1526 as shown in FIG. 5, background or “zero” pixels of the magnitude field are in a given shade of gray, shown for example at a pixel 1525. Shades increasingly darker than the background gray indicate progressively stronger negative magnitudes; correspondingly, lighter shades indicate progressively stronger positive magnitudes.

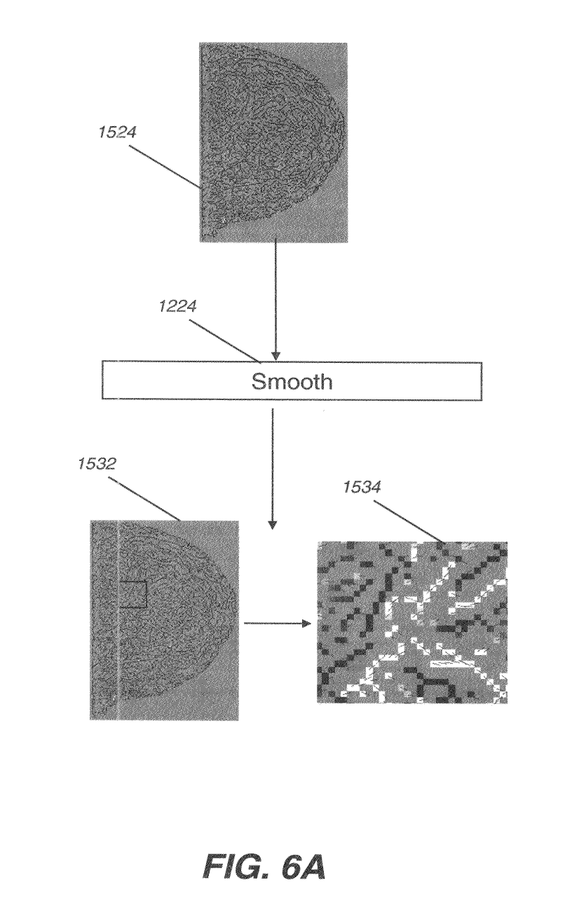

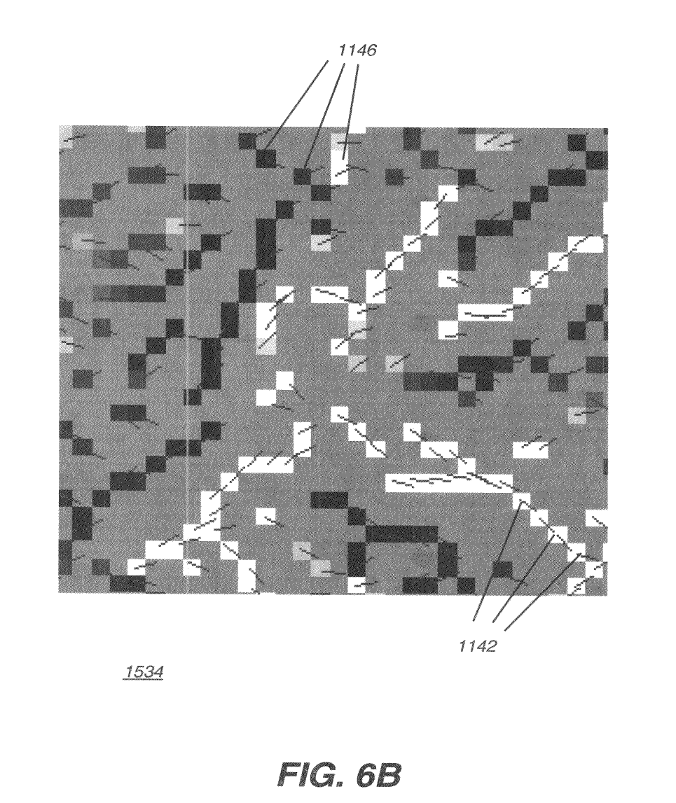

Referring to FIG. 6A, the NMS processed orientation field of image 1524 is processed in an optional smoothing step 1224 in order to reduce noise. For this purpose, a Gaussian filter is used in one embodiment.

Let h(x,y) be a Gaussian filter of standard deviation σₛₘₒₒₜₕ, defined as

$$h ( x , y ) = \frac{1}{2 {πσ}_{smooth}} exp [ - \frac{1}{2} ( \frac{{x}^{2} + {y}^{2}}{{σ}_{smooth}^{2}} ) ] \qquad ( 4 )$$

Define the images

s(x,y)=M_{NMS}(x,y)sin[θ(x,y)] (5)

and

c(x,y)=M_{NMS}(x,y)cos[θ(x,y)] (6)

then, the filtered orientation field angle θₛₘₒₒₜₕ(x,y) smoothed orientation field 1532 (FIG. 6A) is obtained as

$${θ}_{smooth} ( x , v ) = \frac{1}{2} arctan ( \frac{( h \times s ) ( x , y )}{( h \times c ) ( x , y )} ) \qquad ( 7 )$$

In FIG. 6A, Image 1524 is an orientation field of breast tissue after NMS processing as described in FIG. 5. Smoothed orientation field 1532 shows the resulting smoothed orientation field. An image 1534 shows the smoothed version of image 1526 from FIG. 5. FIG. 6B shows an enlarged version of image 1534, showing individual vector elements 1142 of the smoothed orientation field, overlaid on pixel elements 1146 of the image. In FIG. 6B, the background pixels correspond to those that are not part of the orientation field.

Depending on the size of the defined Gabor filter and how well it fits locally in a different image structure, the orientation field that it produces can be noisy, which may affect subsequent phase portrait matching. As has been shown, the orientation field directly generated by the Gabor filter bank may be further smoothed to provide more continuous orientation information and to focus on major image structures. This orientation field will be further analyzed by phase portrait modeling to find potential architectural distortion lesion locations.

### Portrait Modeling and Matching

### Phase Portrait Modeling

As described previously with respect to the logic flow in FIG. 2, phase portrait modeling and matching step 1300 uses the orientation field extracted and smoothed in step 1200 as input and applies multi-scale phase portrait templates to match and recognize a pattern in underlying image structure, i.e. either node, saddle or spiral pattern, etc.

In general, phase portrait technique provides analytical tools to study systems of first-order differential equations. This technique has proved to be useful in characterizing oriented texture: the geometrical patterns in the phase portraits of systems of two, linear, first-order differential equations can be associated with the patterns encountered in an image presenting oriented texture. Phase portrait modeling has been widely used with dynamic systems and in finger print recognition, for example, to detect critical points. Here, it helps to focus on and recognize the main structure in the orientation field in a local manner, without being overly biased by noisy image structure data.

The phase portrait modeling technique uses global optimization to find a best match between a configurable, or deformable, phase portrait template and underlying image structure. Then, based on the properties of the matched phase portrait template, this modeling recognizes whether or not it detects a characteristic architectural distortion pattern (in particular, a node phase portrait pattern, as described in more detail subsequently). The snatching process iterates through each pixel in the orientation field and categorizes and identifies the underlying image structure. The result of such a process is a feature map that has the same size as the input orientation field and that quantifies the probability of architectural distortion in each location.

A phase portrait displays the possible trajectories, in the phase plane, of the state of a dynamical system. Consider the following system of linear first-order differential equations:

$$( \begin{matrix}\dot{p} ( t ) \\ \dot{q} ( t )\end{matrix} ) = A ( \begin{matrix}p ( t ) \\ q ( t )\end{matrix} ) + b \qquad ( 8 )$$

where A is a 2×2 matrix and b is a 2×1 column matrix (a vector). The functions p(t) and q(t) represent the state variables of a dynamical system, as a function of time (e.g., the position and the momentum of a particle, or the pressure and the temperature of a gas). Elements \dot{p}(t) and \dot{q}(t) represent actual transformed values of the system.

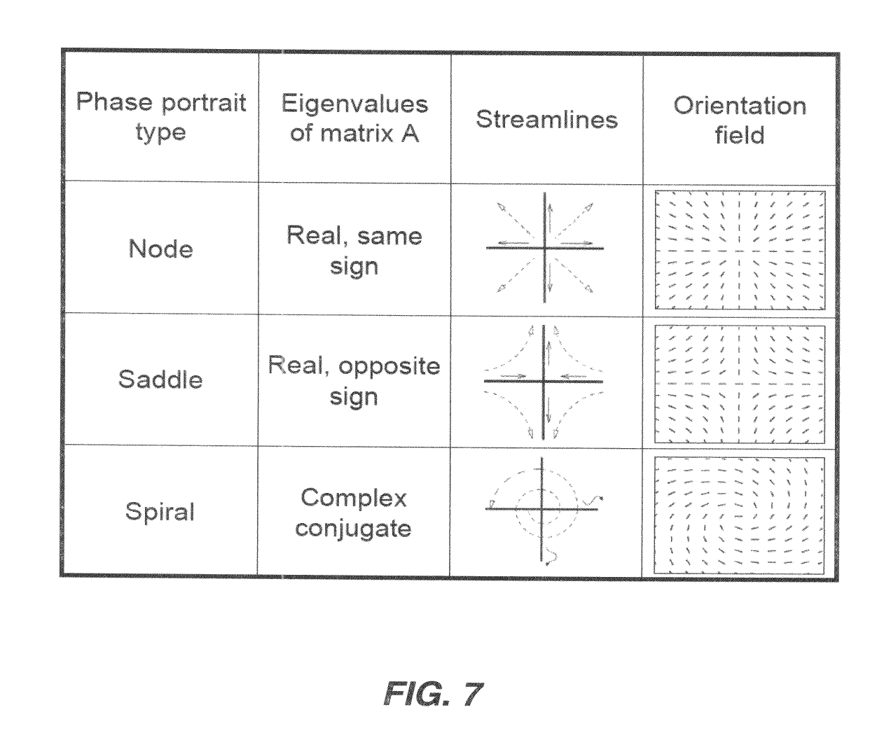

In this case, there are three possible types of phase portraits of interest: node, saddle, and spiral. The node type pattern is of particular value for assessing architectural distortion. The chart in FIG. 7 shows the characteristic pattern of each phase portrait type and describes the corresponding eigenvalue of its related transformation matrix A. It has been found that the type of phase portrait can be determined from the nature of the eigenvalues of matrix A, as shown in the table of FIG. 7. The center (p₀,q₀) of the phase portrait is given by the fixed point of Eq. (9):

$$( \begin{matrix}\dot{p} ( t ) \\ \dot{q} ( t )\end{matrix} ) = 0 ⇒ ( \begin{matrix}{p}_{0} \\ {q}_{0}\end{matrix} ) = - {A}^{- 1} b \qquad ( 9 )$$

The model in Eq. 8 can thus be used to analyze an orientation field, such as the mammographic orientation field generated using procedures described previously. Consider the following vector field model:

$$v = ( \begin{matrix}{v}_{x} \\ {v}_{y}\end{matrix} ) = A ( \begin{matrix}x \\ y\end{matrix} ) + b \qquad ( 10 )$$

The vector v is an affine function of the coordinates (x,y). As phase portrait modeling is conventionally applied, a particle on the Cartesian (image) plane whose velocity is given by v(x,y) will follow a trajectory that is analogous to the time evolution of the dynamical system in Eq. (8). Therefore, Eq. 10 can be compared to Eq. 8 by associating the vector v with the state velocity (\dot{p}(t),\dot{q}(t); and the position (x,y) with the state (p(t), q(t). The orientation field generated by Eq. 10 can be defined as:

$$φ ( x , y \vert A , b ) = arctan ( \frac{{v}_{y}}{{v}_{x}} ) \qquad ( 11 )$$

which is the angle of the vector v with the x axis. FIG. 7 shows the three different phase portrait types and the corresponding orientation fields generated by a system of linear, first-order differential equations.

Using the concepts presented above, methods of the present invention qualitatively describe the orientation field of a textured image by locally identifying the type of phase portrait that is most similar to the orientation field, along with the center of the phase portrait, in order to detect and localize architectural distortion.

### Phase Portrait Matching

For phase portrait matching, an analysis window of w×w pixels is moved sequentially, pixel by pixel, to each position in the smoothed orientation field θₛₘₒₒₜₕ(X). At each position of the analysis window, the phase portrait model parameters that best represent the orientation field, matrix A and vector b (in Eq. 8), are estimated. In order to estimate A and b, let Δ(x,y|A,b) be a measure of the error between the smoothed orientation field θₛₘₒₒₜₕ(x,y) and the calculated orientation φ(x,y|A,b) given by the model, at the pixel location (x,y). The error measure is defined as:

Δ(x,y|A,b)=sin[θₛₘₒₒₜₕ(x,y)−φ(x,y|A,b)] (12)

Estimates of A_{obt} and bₒₚₜ that minimize Δ(x,y|A,b) are obtained using simulated annealing in one embodiment, applying techniques familiar to those skilled in the image processing art. Alternately, some other suitable method for estimating assessment and adjustment according to error calculation can be used.

As shown in FIG. 7, properties of the eigenvalue of Aₒₚₜ determine the type of phase portrait. The fixed-point location, ideally corresponding to the center of the phase portrait template applied in using the model, is determined by computing Equation 9.

For detection of architectural distortion, the node map is computed. If the eigenvalues of Aₒₚₜ are real and of the same sign, the pixel in the node map that corresponds to the fixed point in the phase portrait template is incremented by 1 as the feature map is formed. In order to prevent numerical instabilities in the computation of A⁻¹, results are discarded for node type matching that has a fixed point far away from the center of the phase portrait template.

### Multi-Scale Phase Portrait Matching

Architectural distortion lesions vary in size over a large range. In order to detect architectural distortion at different sizes, a multi-scale approach is used. One approach would be to scale the smoothed orientation field θₛₘₒₒₜₕ(X) to two or more resolutions and then to process each orientation field individually; however, this would require considerable processing time and resources. Instead, embodiments of the present invention successively apply phase portrait templates of multiple scales or sizes to the orientation field θₛₘₒₒₜₕ(X).

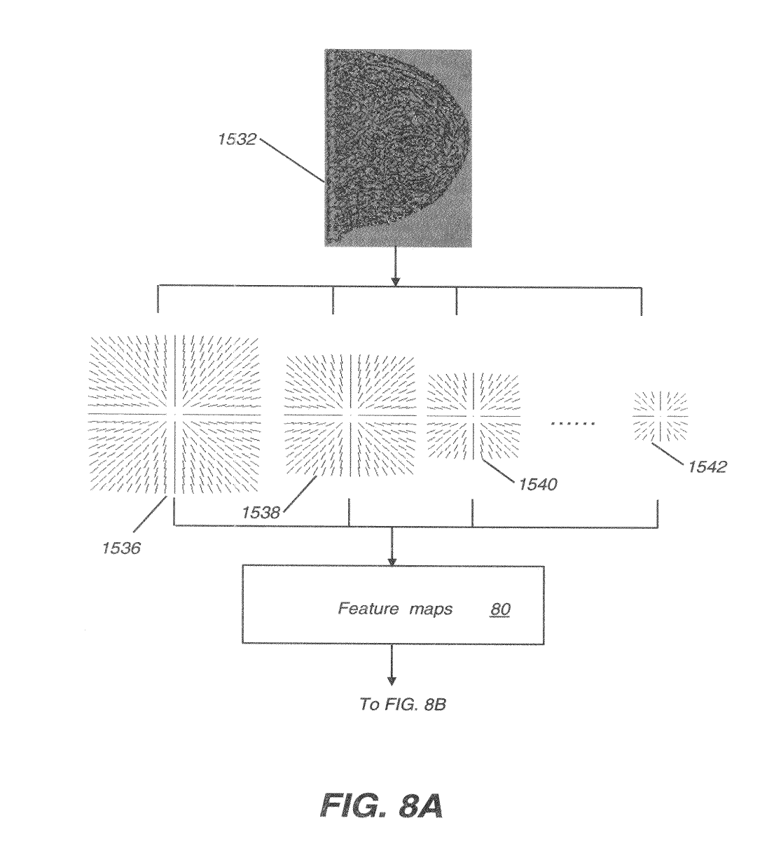

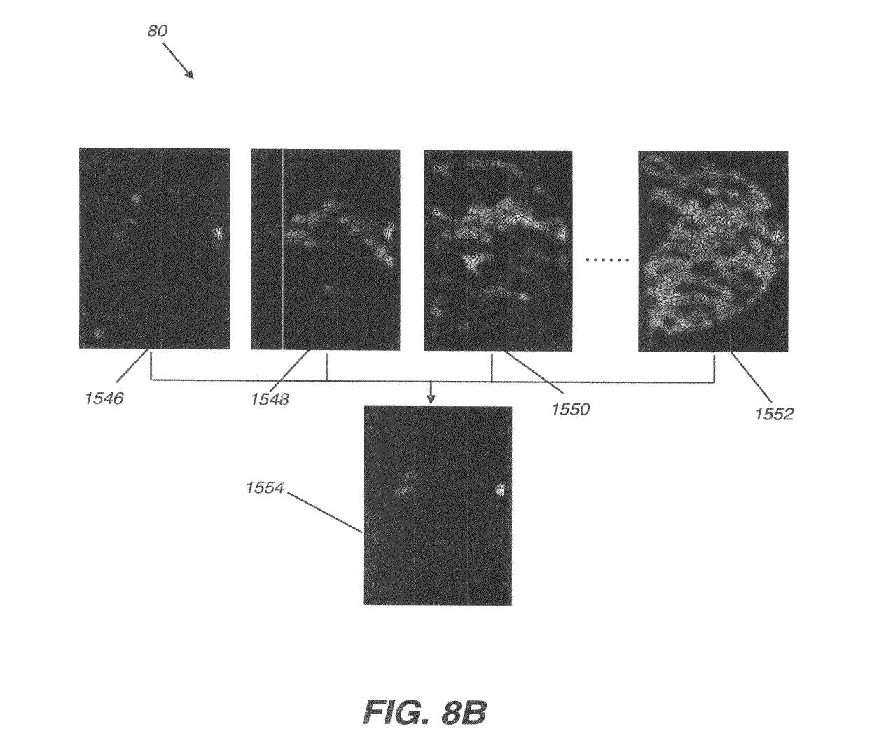

FIGS. 8A and 8B illustrate various steps of multi-scale phase portrait matching according to an embodiment of the present invention. Phase portrait templates 1536, 1538, 1540, . . . , 1542 have different sizes, such as 5×5 pixels corresponding to the size of 5×5 cm², and larger sizes such as 7×7 cm² and 9×9 cm², for example. Each of these phase portrait templates is sequenced through θₛₘₒₒₜₕ(X), smoothed orientation field 1532, to generate each of a corresponding set of feature maps 80. FIG. 8B shows feature maps 1546, 1548, 1550, . . . , 1552 within set of feature maps 80, each feature map identifying a different focused size of architectural distortion lesion. In the example of FIGS. 8A and 8B, each of phase portrait templates 1536, 1538, 1540, . . . , 1542 corresponds to a respective feature map 1546, 1548, 1550, . . . , 1552. As is further shown in FIG. 3B, the individual feature maps 1546, 1548, 1550, . . . , 1552 are then integrated to form a combined feature map 1554, n(X) which confirms the detection of architectural distortion from information that was obtained at different scales. Because the smaller scale phase portrait templates tend to generate proportionally more noise than larger scale phase portrait templates for the same image data, a corrective weighting can be applied to individual feature maps based on scale.

In the example of FIG. 8B, white rectangles in feature maps 1546, 1548, 1550, . . . , 1552 show the location of an architectural distortion confirmed by biopsy. Here, all feature maps resulted in high values within their corresponding rectangular regions, thus increasing confidence that the marked region has an architectural distortion as determined by the algorithm. The combined feature map 1554 confirms this finding. False positives in individual feature maps were suppressed by this combined approach.

### Architectural Distortion Feature Extraction

As noted earlier with respect to FIG. 2, feature extraction step 1600 extracts a set of features that help to discriminate architectural distortion from normal tissue for each candidate. Extracted features include measures of both magnitude and statistics. Using magnitude based features helps to discriminate an architectural distortion candidate solely based on its local pattern in a feature map. Using statistical features also takes into account neighboring pattern information.

The estimates of the fixed point location for a given phase portrait pattern can be somewhat inaccurate, scattered around the true fixed point position due to factors such as the limited precision of the estimation procedure, the presence of multiple overlapping patterns, the availability of limited data within the sliding analysis window, and image noise. A local accumulation of the votes is necessary to diminish the effect of fixed point location errors. In one embodiment, a Gaussian smoothing filter is employed to smooth the resulting feature map for this purpose.

For the purpose of pattern classification, two features in particular are extracted and can be used to characterize each ROI of a suspected architectural distortion lesion: (i) the maximum of the node map and (ii) the entropy of the node map. The maximum value of the node map conveys information about the likelihood that a node phase portrait type is present. The entropy value relates to the uncertainty in the location of the fixed point in the node map. The entropy η of node map n(x,y) is computed as:

$$η \{ n ( x , y ) \} = - {\sum }_{x} {\sum }_{y} \frac{n ( x , y )}{{S}_{n}} ln \frac{n ( x , y )}{{S}_{n}} \qquad ( 13 )$$

Where Sₙ is the normalization factor and defined as:

$${S}_{n} = {\sum }_{x} {\sum }_{y} n ( x , y ) .$$

Features that have been extracted as part of step 1600 (FIG. 2) can be combined with features obtained from other systems that perform computer-aided detection for the same image. Other features can include morphological features, density features, spatial features, texture features, and spiculation features, for example. A Gaussian Discrimination Function (GDF) can be used to select a subset of features that can best discriminate architectural distortion tissue from normal tissue.

Methods of the present invention can be used with systems that can be trained to classify architectural distortion with improved accuracy over time, such as with classification systems employing neural network (NN) classifier logic, for example. Results from a set of training cases as well as from actual patient studies can be used to help train and refine the decision-making process from an NN system, using techniques well known to those skilled in the data analysis arts.

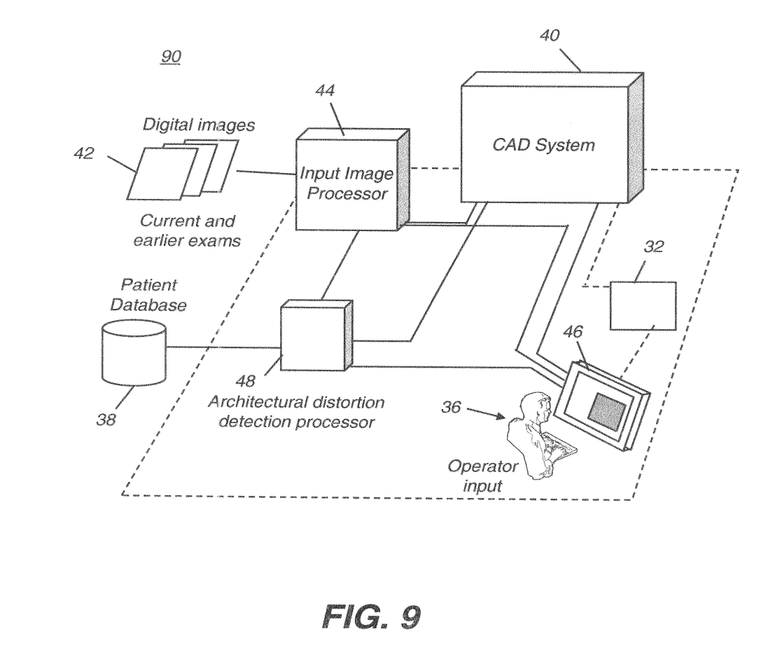

Referring to FIG. 9, embodiments of a system for architectural distortion detection 90 according to the present invention execute on a CAD (Computer-Aided Detection) system 40 that cooperates with an input image processor 44 and provides the control logic processing, data storage, input/output, and display 46 components that support automated detection for improved diagnosis. Digital images 42 from current and earlier exams, generated using either scanned film or from computed radiography (CR) or digital radiography (DR) systems, are provided to input image processor 44 that, in response to stored instructions, obtains the images and provides a number of the image processing functions described previously, and transmits processed image data to other CAD system 40 components for preprocessing to detect and report architectural distortion and to memory or storage circuitry. Extracted data from input image processor 44 goes to an architectural distortion detection processor 48 or subsystem in communication with input image processor 44 that provides further processing and analysis based on stored modeling logic instructions, executing the sequence described previously with reference to the logic flow diagram of FIG. 2. A patient database 38 can store other relevant information such as age, family history and patient history, accessible for risk modeling. A control console 36 is provided for viewer input of instructions and control parameters, working in conjunction with display 46.

It can be appreciated that the overall arrangement of FIG. 9 admits any of a number of alternative embodiments, with various possible types of computers or other control logic processors, including networked computers and processors, with memory and data storage components incorporated within or otherwise associated with each of the processors shown, such as by network connections. Stored program instructions and data enable the execution of the various processes and algorithms used by CAD system 40 and related control logic processors. One or more configuration files 32 can be used to store parameter values used under different conditions. In addition, user manipulation of configuration file 32 is permitted in one embodiment, allowing an operator or diagnostician to adjust variable parameters that control different parts of image processing.

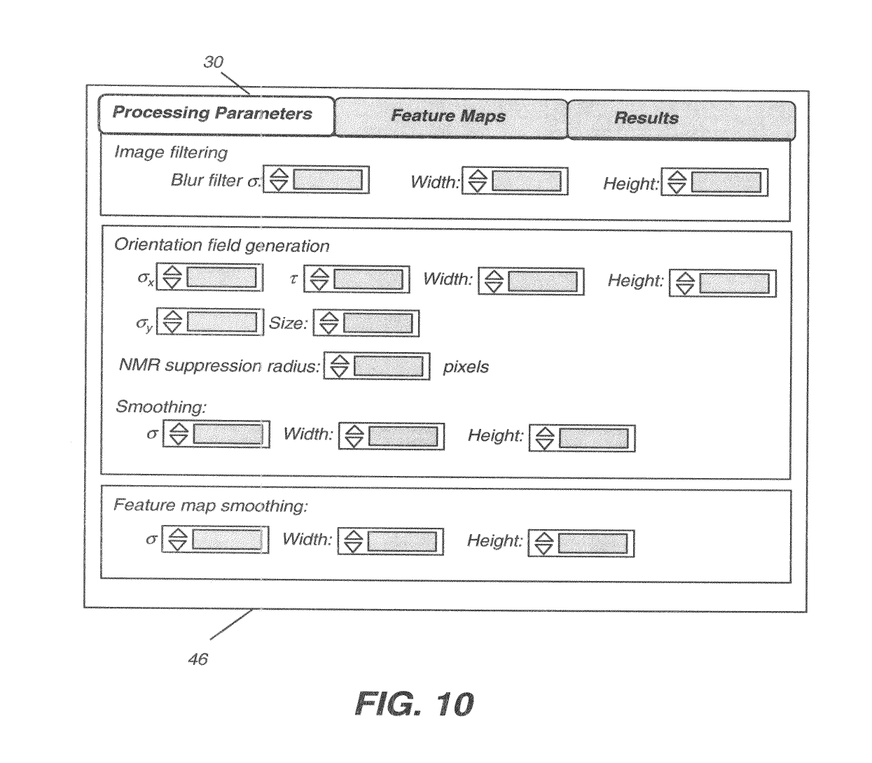

An operator interface can be provided for allowing adjustment of variable parameters used in processing image data and for display of interim results. Parameters can be adjusted for conditioning the image data, for conditioning orientation field generation, or for conditioning feature map generation. FIG. 10 shows a plan view of display 46 configured for operator entry of some portion of the variable processing parameters. A tab 30 is used to select a suitable parameter entry or display window. Exemplary parameter entries are shown; alternate sets of parameters could be used. In the example of FIG. 10, the operator can adjust values for conditioning initial high-pass filter processing of the image, as was described with reference to high-pass filter step 1106 in FIG. 3A, such as by adjusting σ, width, and height values for the blur filter. Parameters used in orientation field generation can also be adjusted, including σ, τ, width, and height values as well as bank size for Gabor filtering. Additional smoothing values can also be adjusted, such as for smoothing of the orientation field and feature map. It can be appreciated that additional adjustments, not shown in the example of FIG. 10, could alternately be made by the operator, including, but not limited to, fixed point threshold values, gradient optimization values for intermediate pixels between annealed values, and phase portrait template radius, for example. Selection of other tabs 30 enables the operator to view the results of any adjustments made to condition the image processing and computer-aided detection functions of various embodiments. Interim results, such as the orientation field or feature map, can be displayed as well as final results.

The invention has been described in detail with particular reference to a presently preferred embodiment, but it will be understood that variations and modifications can be effected within the spirit and scope of the invention. For example, the overall procedure described with reference to FIG. 2 could be used for detecting spiculation and related image features. The presently disclosed embodiments are therefore considered in all respects to be illustrative and not restrictive. The scope of the invention is indicated by the appended claims, and all changes that come within the meaning and range of equivalents thereof are intended to be embraced therein.

1. A method for detecting architectural distortion within mammographic image data, comprising:
identifying breast tissue within the image data;
generating an orientation field and a corresponding magnitude field within the identified breast tissue;
generating a feature map by processing the orientation field with a phase portrait model at one or more image scales;
identifying one or more architectural distortion features according to the generated feature map; and
displaying the one or more identified architectural distortion features.

2. The method of claim 1 wherein identifying breast tissue comprises identifying a skin line.

3. The method of claim 1 wherein generating an orientation field comprises applying one or more Gabor filters to identified breast tissue portions of the mammographic image data.

4. The method of claim 1 wherein identifying the breast tissue further comprises down-sampling the image data.

5. The method of claim 1 further comprising applying a high-pass filtering operation to at least identified breast tissue portions of the mammographic image data.

6. The method of claim 1 wherein generating a feature map comprises calculating an eigenvalue for a transformation matrix and generating feature map data according to the calculated eigenvalue.

7. The method of claim 1 wherein identifying the one or more architectural distortion features comprises obtaining either or both a maximum value and an entropy value using the generated feature map.

8. The method of claim 1 further comprising using the one or more identified architectural distortion features to train a classification system.

9. The method of claim 1 further comprising obtaining parameter values entered by a user for conditioning the image data, for conditioning orientation field generation, or for conditioning feature map generation.

10. The method of claim 9 wherein obtaining the parameter values comprises obtaining, from a configuration file that is manipulated by the user, values for using a Gabor filter bank.

11. The method of claim 1 further comprising displaying an indicator of relative risk for one or more of the identified architectural distortion features.

12. The method of claim 1 further comprising applying simulated annealing for matching between a phase portrait template and underlying image structure defined in the generated orientation field.

13. The method of claim 1 wherein generating a feature map comprises obtaining phase portrait matching results having a node pattern.

14. The method of claim 3 wherein generating an orientation field further comprises applying non-maximum suppression to the results from Gabor filtering.

15. The method of claim 1 further comprising processing the feature map using a Gaussian discrimination function to select a subset of features that discriminate architectural distortion tissue from normal tissue.

16. A detection system for architectural distortion in mammography comprising:
an input image processor that is responsive to stored instructions for obtaining a digital or digitized mammography image;
a computer-aided detection system having an architectural distortion detection processor that is responsive to stored instructions for generating a breast tissue structure orientation field as well as generating a corresponding magnitude field, for generating a node feature map by matching one or more predetermined multi-scale phase portrait templates with underlying image structure in the orientation field, for extracting architectural distortion related features from the generated feature map, for selecting a subset of features that discriminate architectural distortion tissue from normal tissue, and for building a neural network classifier based on a selected subset of features; and
a display operatively connected with the computer-aided detection system and actuable to display the extracted architectural distortion related features.

17. The detection system of claim 16 further comprising an operator interface configurable to accept viewer instructions and adjustments to parameters that condition the performance of the computer-aided detection system.

18. The detection system of claim 16 further comprising one or more configuration files for providing parameters used by the computer-aided detection system.
